(19) United States
(12) Patent Application Publication
(10) Pub. No.: US 2007/0258175 A1
(43) Pub. Date: Nov. 8, 2007

(54) METHOD AND APPARATUS FOR OPEN NEUTRAL FAULT DETECTION

(76) Inventors: Steven R. Montgomery, Kitchener (CA); Nicolas Jones, Kitchener (CA)

Correspondence Address: VALENTINE A COTTRILL, 50 QUEEN STREET NORTH, STE. 1020, P.O. BOX 2248, KITCHENER, ON, N2H6M2, CA

(21) Appl. No.: 11/746,045

(22) Filed: May 8, 2007

Related U.S. Application Data
(60) Provisional application No. 60/746,718, filed on May 8, 2006.
(60) Provisional application No. 60/867,674, filed on Nov. 29, 2006.

(51) Int. Cl. H02H 3/00

(52) U.S. Cl. 361/42

(57) ABSTRACT

A method and apparatus for detecting an open neutral fault condition in a circuit including a neutral conductor and first and second live conductors. The method begins with determining a voltage imbalance between a first voltage between the first live conductor and the neutral conductor, and a second voltage between the second live conductor and the neutral conductor. Next, the voltage imbalance is compared to a predetermined threshold value. If the voltage imbalance exceeds the predetermined threshold value, an alarm signal is generated.

This application claims the benefit of U.S. Provisional Application No. 60/746,718, filed on May 8, 2006, and also claims the benefit of U.S. Provisional Application No. 60/867,674, filed on Nov. 29, 2006.

### FIELD OF THE INVENTION

This invention is related to a detector for detecting an open neutral fault in an electrical circuit with a neutral conductor and two live conductors.

### BACKGROUND OF THE INVENTION

Open Neutral Faults are responsible for a number of fires and represent a significant safety hazard. This type of fault occurs frequently enough that Underwriters' Laboratories (UL) includes tests in UL-1449 (Transient Voltage Surge Suppressors) intended to assess a surge suppressor's resistance to starting a fire when this fault occurs.

Typical North American Residential and Light Commercial Distribution System

North American residential and light commercial electrical systems use a single-phase, split-leg three wire scheme nominally delivering 120VAC and 240VAC for use by household equipment and appliances. FIG. 1 illustrates a simplified household electrical system from the street transformer to the breaker panel.

The street transformer converts the local distribution voltage down to 240V. The 240V secondary winding on the transformer is tapped in the center to provide for the connection of both 120V and 240V loads.

The center tap conductor is also bonded to earth ground and is commonly called Neutral. The other two conductors are called Live or Hot (labeled L1 and L2 in FIG. 1).

The breaker panel is designed so that adjacent breakers are connected to different live conductors. 120V circuits use a single pole breaker and connect to either L1 or L2 and Neutral. 240V circuits use a dual pole breaker and connect to both L1 and L2. 240V circuits also include Neutral so that connected loads (e.g., clothes dryers) can have both 120V and 240V circuits.

In a typical house about half of the 120V circuits are connected to L1 and the other half are connected to L2. All of the 240V loads are connected between L1 and L2. FIG. 2 is simplified to show only the transformer and the loads.

Open Neutral Faults

Open neutral faults occur when the neutral conductor between the breaker panel and the transformer becomes partially or completely disconnected. A common cause is a loose wire connection inside the breaker panel. FIG. 3 illustrates a typical open neutral fault.

This type of fault can be very dangerous since 120V loads may experience voltage exceeding 200V which creates an extraordinary fire and shock hazard. However, the open neutral does not disable the household electrical system. Also, the open neutral does not affect 240V loads since both L1 and L2 are still properly connected the load still receives 240V and operates normally.

120V circuits rely on the neutral conductor as a return path to the transformer. Accordingly, when the neutral is open the current finds an alternative path through loads connected to the other live conductor.

FIG. 4 shows how a circuit exists through two 120V loads connected to different circuits. This condition results in a number of strange symptoms (described further below) and dangerous conditions. (As will be described, the remainder of the drawings illustrate the present invention.)

As FIG. 4 illustrates, 240V loads still receive 240V and operate normally. With the neutral open, 120V loads connected to the two live conductors are effectively placed in series to form a 240V load. If the 120V loads connected to L1 and L2 were identical there would not be a problem, because in that situation both loads would receive 120V and would operate normally.

In practice, however, the loads connected to L1 and L2 are usually not identical. As a result, the voltage applied to each load can vary from nearly zero to as much as 240V.

Symptoms of Open Neutral Faults

The following conditions are typical consequences of open neutral faults:
Changing loads (turning lights and equipment on/off) results in some lights getting brighter, and other lights getting dimmer, due to the changing loads between L1 and L2. One set of circuits will experience an increase in voltage, and the other set of circuits experiences an equivalent decrease in voltage.
If no load is present on one live circuit (L1), then no current flows through any load on the other live circuit (L2). When an L1 load is connected or turned on, then appliances and lights connected to the other live circuit (L2) become energized since L2 completes the circuit for L1.
Surge suppressors can trip and fail due to the excess voltage. Safety Hazards of Open Neutral Faults

Hazards resulting from open neutral faults (i.e., due to 120V devices being exposed to high voltages up to 240VAC) are as follows:
Personal care appliances (curling irons, hair dryers etc.) can produce excessive heat or otherwise malfunction which can result in serious burns and other injuries;
Electrical equipment and lights, particularly recessed and enclosed ceiling fixtures, may overheat, presenting a fire hazard;
Electrical devices may draw excessive current causing overheating of supply wires, extension cords, and in-wall wiring, resulting in fire. Significant overheating can degrade or melt insulation resulting in shock hazards;
Surge suppressors not tested to UL or Canadian Standard Association standards may experience thermal runaway resulting in extremely high temperatures (often red-hot) and risk of fire;
Compact fluorescent bulbs contain electronic circuits that include electrolytic capacitors. It has been demonstrated that exposure to voltages between 120VAC and 240VAC can result in failure of these capacitors and venting of electrolyte fluid. This fluid contains potassium hydroxide and other trace chemicals, and is caustic. Venting of electrolyte in overhead light fixtures can lead to a mist of caustic chemicals that pose a significant hazard to any persons in the vicinity.
A partially open neutral (i.e. loose connection) can arc, leading to further damage in the vicinity of the connection and fire hazard.
   Financial Loss Hazards

In addition, an open neutral fault may cause one or more of the following, resulting in financial losses:
Electrical equipment, lights, AV and computer equipment may be damaged or destroyed;
Overheated extension cords and electrical device cords can overheat and damage flooring, furniture and other items;
In-wall wiring insulation can suffer heat stress requiring replacement.
   Recessed & Flush Lamps

Ceiling light fixtures currently available are intended for semi-flush, flush or recessed mounting. Recessed fixtures are rated for use in insulated and non-insulated ceilings.

Flush and semi-flush mount ceiling fixtures have no requirements for supplementary protection and rely on proper installation and use to maintain safety.

Approved recessed lights manufactured since the early 1980s are required to have thermal protection to detect excessive heat build-up caused by over-wattage lamps, incorrect type of lamp or incorrect installation (e.g., non-insulated ceiling type installed in an insulated ceiling). This thermal protection provides a significant improvement in safety, however, it is not precise enough to detect less significant overloads and moderate overheating that can still cause long-term damage to insulation and wire connections.

All types of fixtures are susceptible to overheating due to abnormal voltage conditions. Short-term abnormal voltage conditions can damage light bulbs but do not pose a significant safety hazard. Long-term abnormal voltage conditions can cause overheating leading to premature failure of wiring insulation, arcing and fire.

Over-Wattage Lamps—Long-Term Arcing and Fire Hazard

All light fixtures are marked with the maximum number and wattage of lamps to be installed. Users, not understanding the long-term risk, frequently install lamps with higher wattages than the fixture is rated for. Exceeding the ratings of a fixture results in abnormally high temperatures within the fixture, long-term damage to wire insulation, and increased risk of arcing and fire.

Open Neutral—Long-Term Arcing and Fire Hazard, Short-Term Equipment Damage Hazard

Open neutral faults cause a voltage imbalance between circuits connected to the two live feed conductors. The circuit with the heaviest load (lowest resistance) experiences abnormally low line voltage. The remaining circuits experience abnormally high line voltage. Abnormally high voltages results in overheating, and if not detected, can cause long-term damage to wiring insulation.

Power Fluctuations—Short-Term Equipment Damage Hazard

Power fluctuations, predominantly abnormally high voltages, caused by power utility regulation problems present a short-term damage risk to lamps. Damage is typically limited to burned-out light bulbs but in the case of fluorescent lighting and other types of lamps with electronic components, failures can include arcing and potential ignition of flammables.

### SUMMARY OF THE INVENTION

In its broad aspect, the invention provides an open neutral fault detector for monitoring an electrical circuit including a neutral conductor and first and second live conductors. The open neutral fault detector includes means for determining a voltage imbalance between a first voltage (i.e., between the first live conductor and the neutral conductor) and a second voltage (i.e., between the second live conductor and the neutral conductor). The open neutral fault detector also includes a means for comparing the voltage imbalance to a predetermined threshold value, and means for generating an alarm signal if the voltage imbalance exceeds the predetermined threshold value.

In another aspect, the open neutral fault detector includes means for measuring a first voltage between the first live conductor and the neutral conductor and means for measuring a second voltage between the second live conductor and the neutral conductor. The open neutral fault detector also includes means for comparing the first voltage and the second voltage to determine an imbalance therebetween, and means for generating an alarm signal if the imbalance is greater than a predetermined threshold value.

In another of its aspects, the open neutral fault detector additionally includes means for comparing the first voltage to a voltage limit selected from the group consisting of a predetermined maximum voltage and a predetermined minimum voltage. The open neutral fault detector also includes means for comparing the second voltage to the voltage limit, a means for generating an alarm signal upon any one of the first voltage and the second voltage violating the voltage limit.

In yet another aspect, the invention provides an open neutral fault detector for monitoring an electrical circuit including a neutral conductor and first and second live conductors. The open neutral fault detector is installed in a branch circuit including the neutral conductor and a selected one of the live conductors. The open neutral fault detector includes means for measuring a voltage between the selected live conductor and the neutral conductor, and means for comparing the voltage to a voltage limit. The voltage limit is selected from the group consisting of a predetermined upper limit and a predetermined lower limit. The open neutral fault detector also includes means for generating an alarm signal if the voltage violates the voltage limit.

### BRIEF DESCRIPTION OF THE DRAWINGS

The invention will be better understood with reference to the attached drawings, in which:

FIG. 1 (also described previously) is a block diagram illustrating a simplified household electrical system, from a street transformer to a service entry panel;

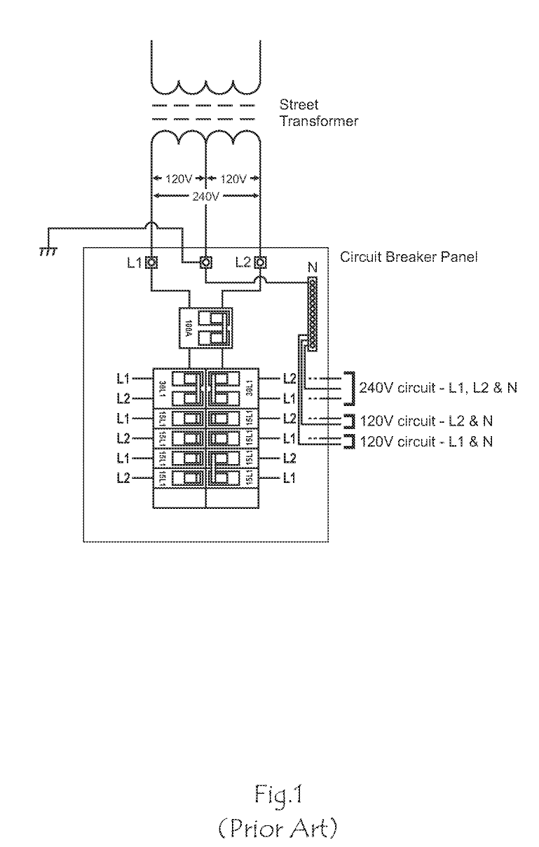

FIG. 2 (also described previously) is a circuit diagram schematically illustrating the elements of FIG. 1;

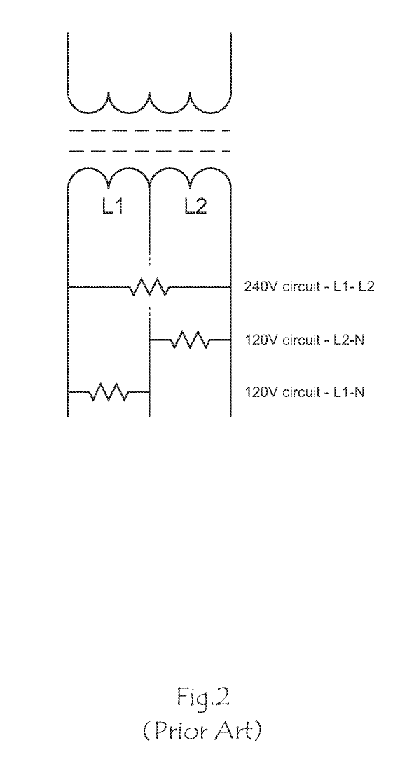

FIG. 3 (also described previously) is a block diagram illustrating an open neutral fault;

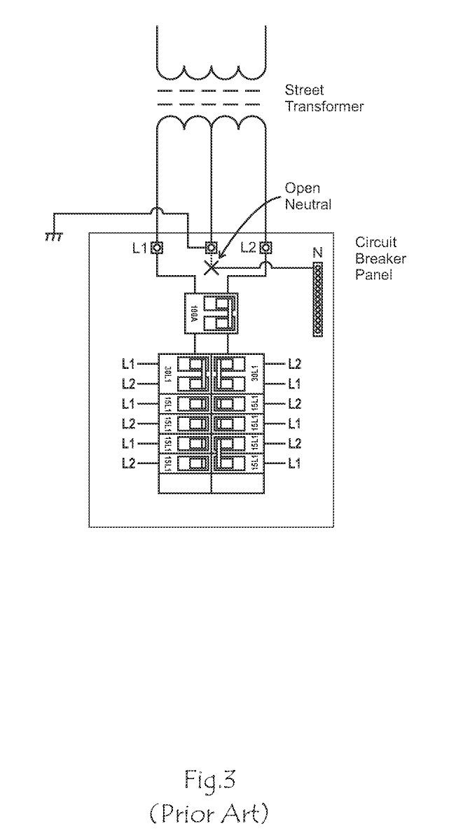

FIG. 4 (also described previously) is a circuit diagram schematically illustrating the elements of FIG. 3;

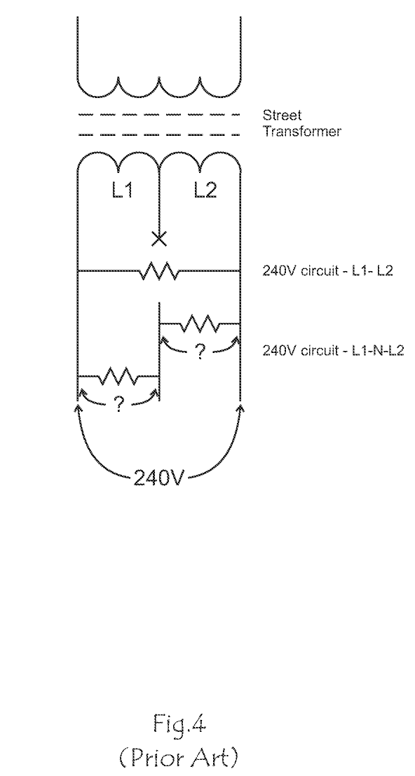

FIG. 5 is a flow chart schematically illustrating an embodiment of a method of the invention;

FIG. 6 is a flow chart schematically illustrating another embodiment of a method of the invention;

FIG. 7 is a flow chart schematically illustrating another embodiment of a method of the invention;

FIG. 8 is a flow chart schematically illustrating another embodiment of a method of the invention;

FIG. 9 is a flow chart schematically illustrating another embodiment of a method of the invention;

FIG. 10 is a flow chart schematically illustrating another embodiment of a method of the invention;

FIG. 11 is a block diagram representing an embodiment of an open neutral fault detector of the invention;

FIG. 12 is a block diagram representing an embodiment of a control circuit of the invention;

FIG. 13 is a block diagram representing another embodiment of the open neutral fault detector of the invention;

FIG. 14 is a block diagram representing another embodiment of the open neutral fault detector of the invention;

FIG. 15 is a block diagram representing another embodiment of the open neutral fault detector of the invention incorporated into an outlet installed on a branch circuit;

FIG. 16 is a block diagram representing another embodiment of the open neutral fault detector of the invention;

FIG. 17 is a block diagram representing another embodiment of the open neutral fault detector of the invention;

FIG. 18 is an isometric view of another embodiment of an open neutral fault detector of the invention;

FIG. 19 is an isometric view of the open neutral fault detector of FIG. 18 with a cover plate in place thereon;

FIG. 20 is an isometric view of an embodiment of a cover plate subassembly of the invention positioned for installation over a receptacle of the prior art; and

FIG. 21 is an isometric view of the cover plate subassembly of FIG. 20 installed on a receptacle of the prior art.

### DETAILED DESCRIPTION

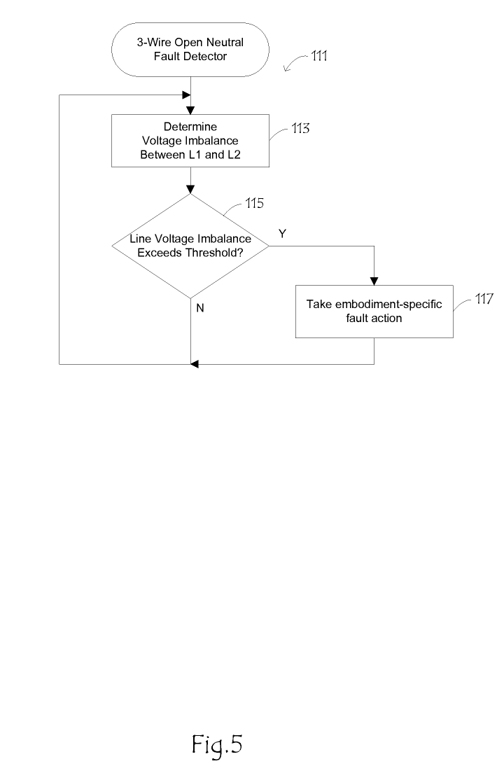

Reference is first made to FIGS. 5 and 11-15 to describe an embodiment of an open neutral fault detector 10 of the invention and an embodiment of a method 111 of the invention for detecting an open neutral fault. FIG. 5 illustrates the method 111 of the operation of the open neutral fault detector 10 through an operational flow chart. As can be seen in FIG. 5, the method 111 begins at step 113, where a voltage imbalance between a first voltage between a first live conductor and a neutral conductor and a second voltage between a second live conductor and the neutral conductor is determined. Next, at step 115, the voltage imbalance is compared to a predetermined threshold value. Finally, at step 117, an alarm signal is generated if the voltage imbalance exceeds the predetermined threshold value.

It will be understood that the voltage imbalance between the first and second voltages may be determined in various ways, as is known by those skilled in the art. For example, the difference between the first and second voltages may be measured. In addition, for the purposes hereof, it will be understood that an imbalance can be zero.

The predetermined threshold value preferably is an appropriate value for the particular application in which the open neutral fault detector 10 is used, i.e., a value which takes into account fluctuations under normal operating conditions in the application. For example, in a typical residential application, a predetermined threshold value may be approximately 5 percent when the voltage imbalance is measured as a ratio. For instance, the ratio is calculated as |L1−L2| divided by the sum of L1 plus L2. Accordingly, if (for example) L1 is 110V and L2 is 120V, then the ratio is determined to be 4.3 percent. Alternatively, the predetermined threshold value may be approximately 12V when the voltage imbalance is measured as a difference.

The predetermined threshold value may be set when the open neutral fault detector 10 is manufactured. Alternatively, the predetermined threshold value may be variable, i.e., a user (not shown) may vary the predetermined threshold value according to the specific conditions in which the open neutral fault detector 10 is used.

Preferably, the voltage imbalance is repeatedly determined at preselected time intervals by measurement of the RMS voltage over single or multiple cycles of the supply voltage waveform. For example, the voltage imbalance may be determined at intervals of 67 mS in the typical residential application. As will be appreciated by those skilled in the art, intervals greater than approximately 67 mS are feasible, but would result in less responsiveness. Smaller intervals are possible, but it is not practical to have a time interval of less than approximately one full cycle at 60 Hz, or 16.6 mS.

Alternatively, the voltage imbalance is determined by continuous measurement of the instantaneous imbalance voltage. The instantaneous imbalance voltage is at a minimum when both voltage waveforms are at approximately zero, and at a maximum when the voltage waveforms reach their peak. The instantaneous imbalance voltage may be directly compared with an imbalance voltage threshold, or may be taken in ratio to the mean instantaneous voltage of the input voltages for comparison with an imbalance ratio threshold.

The alarm signal which is generated is transmitted to a device (or devices) which is activated upon receipt of the alarm signal, as will be described.

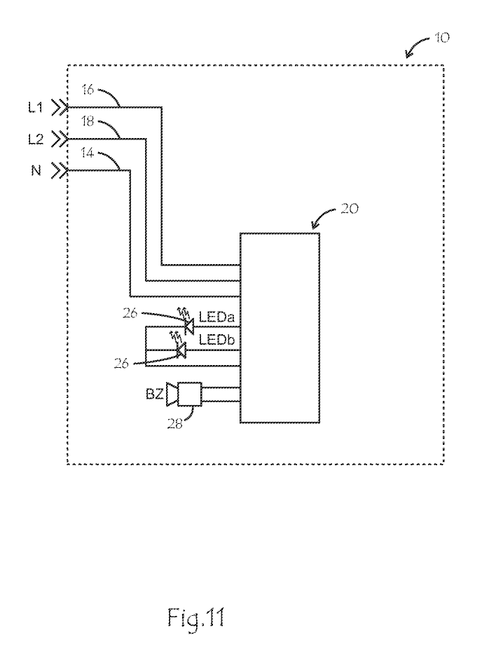

FIG. 11 is a schematic illustration of the open neutral fault detector 10. The open neutral fault detector 10 is for monitoring an electrical circuit with a neutral conductor 14 and first and second live conductors 16, 18. It is preferred that the open neutral fault detector 10 includes a control circuit 20 having a means for determining the voltage imbalance between the first voltage (i.e., the voltage between the first live conductor 16 and the neutral conductor 14) and the second voltage (i.e., the voltage between the second live conductor 18 and the neutral conductor 14). The control circuit 20 preferably also includes a means for comparing the voltage imbalance to a predetermined threshold value. Also, the control circuit 20 preferably includes a means for generating the alarm signal if the voltage imbalance exceeds the predetermined threshold value.

The open neutral fault detector 10, as illustrated in FIG. 11, also includes means 26 for providing a predetermined visual signal, the means being activated upon receipt thereof of the alarm signal. For exemplary purposes only, the means 26 is shown as including two LEDs with appropriate circuitry, but any suitable light-providing or other visual effect provider could be used.

As illustrated in FIG. 11, the open neutral fault detector 10 also includes, for exemplary purposes only, means 28 for providing a predetermined audible signal upon receipt thereof of the alarm signal. For example, the means 28 can be a buzzer, or other suitable device. It will be understood that the open neutral fault detector 10 may include means 26 or means 28 or, if preferred, both.

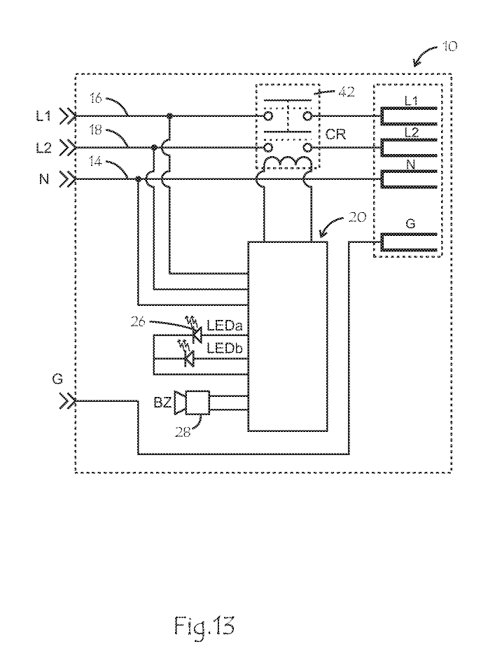

As can be seen in FIG. 13, another embodiment of the open neutral fault detector 10 additionally includes means 42 for disconnecting the first and second live conductors 16, 18 upon receipt thereof of the alarm signal. For example, the open neutral fault detector 10 illustrated in FIG. 13 preferably is included in a receptacle.

FIG. 13 also shows that the embodiment of the open neutral fault detector 10 illustrated therein includes means 26 for providing the predetermined visual signal and means 28 for providing the predetermined audible signal. It will be understood, however, that the open neutral fault detector 10 may include, for example, only one of the means 26, the means 28, and the means 42, or any combination thereof.

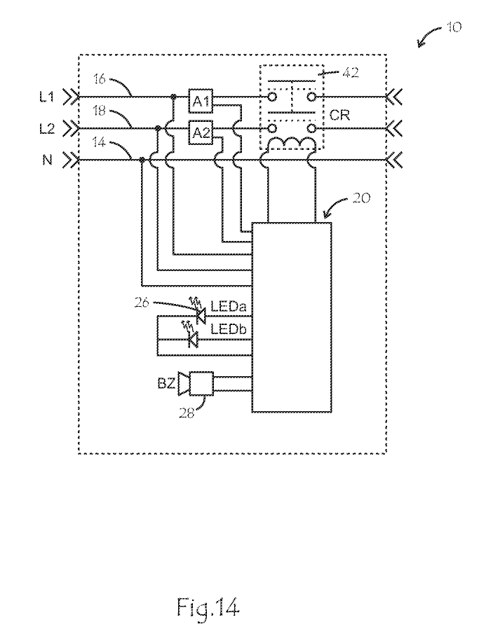

FIG. 14 illustrates another embodiment of the open neutral fault detector 10, which is a circuit breaker, intended for use in a circuit breaker panel. This embodiment of the open neutral fault detector 10 preferably includes means 42 for disconnecting the live conductors 16, 18, activatable upon receipt of the alarm signal, as described above. Optionally, the open neutral fault detector 10 may include the means 26 for providing the predetermined visual signal and/or the means 28 for providing the predetermined audible signal, as described above. As is known in the art, the open neutral fault detector 10 may additionally include current flow sensors A1 and A2, as illustrated in FIG. 14, or similar means to incorporate overcurrent protection in the circuit breaker.

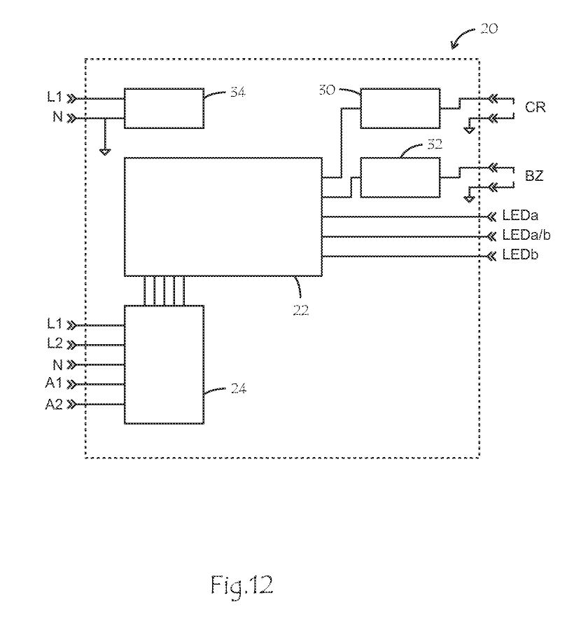

It will be understood that the control circuit 20 may be implemented in various ways, as is known by those skilled in the art. For example, the signal measurement, computation, comparison, alarm signal generation and time delay functions may be implemented using entirely analog circuits, a combination of analog and discrete digital circuits, or with analog circuits and a general purpose microprocessor with suitable software. Preferably, and as illustrated in FIG. 12, the control circuit 20 comprises a microprocessor 22 containing suitable software, analog signal conditioning circuits 24 presenting prepared signals to analog inputs of said microprocessor, relay driver circuit 30 controlled by said microprocessor, annunciator driver circuit 32 controlled by said microprocessor, indicator driver circuits incorporated into said microprocessor and a power supply circuit 34.

As will be appreciated by those skilled in the art, the open neutral fault detector functionality can be incorporated into devices (e.g., receptacles) having other functionality, such as overload fault interrupter, shock fault interrupter, power fault interrupter, ground fault interrupter, arc fault interrupter, and various non-protective functions such as home automation control and communication functions.

In use, the open neutral fault detector 10 is connected to the live conductors and the neutral conductor, so that a voltage imbalance can be determined. Preferably, the open neutral fault detector 10 is adapted to determine the voltage imbalance repeatedly at preselected time intervals. Also, it is preferred that the predetermined threshold value has been set before the open neutral fault detector 10 is installed. In one embodiment, upon the voltage imbalance exceeding the predetermined threshold value, the open neutral fault detector generates the alarm signal, which may be transmitted to another device. As described above, however, it is preferred that the open neutral fault detector additionally include a means for taking an action to address the open neutral fault, upon receipt thereof of the alarm signal.

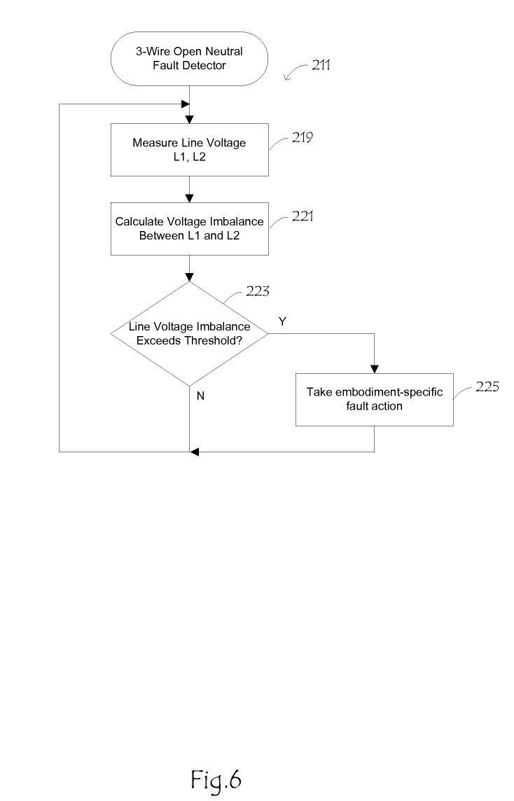

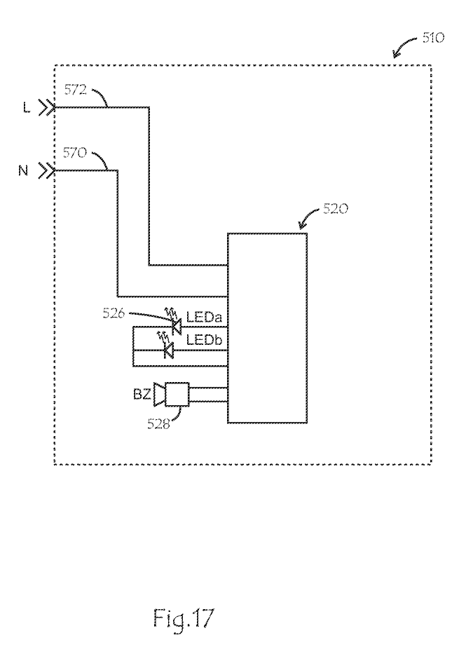

Additional embodiments of the invention are disclosed in FIGS. 6-10 and 16-21. In FIGS. 6-10 and 16-21, elements are numbered so as to correspond to like elements shown in FIGS. 5 and 11-15.

In another embodiment of the method of the invention 211, as shown in FIG. 6, the first voltage between the first live conductor and the neutral conductor is measured, and a second voltage between the second live conductor and the neutral conductor is also measured (step 219). Next, in step 221, the measured first voltage and the measured second voltage are compared to determine an imbalance therebetween. Finally, in step 223, the imbalance is compared to a predetermined threshold value, and if the imbalance is greater than the predetermined threshold value, the alarm signal is generated. Preferably, the alarm signal activates a device (e.g., means 26 for providing the predetermined visual alarm, means 28 for providing the predetermined audible signal, and/or means 42 for disconnecting the live conductors).

It will be understood that the open neutral fault detector 10 may be adapted to carry out the method 211 of the invention.

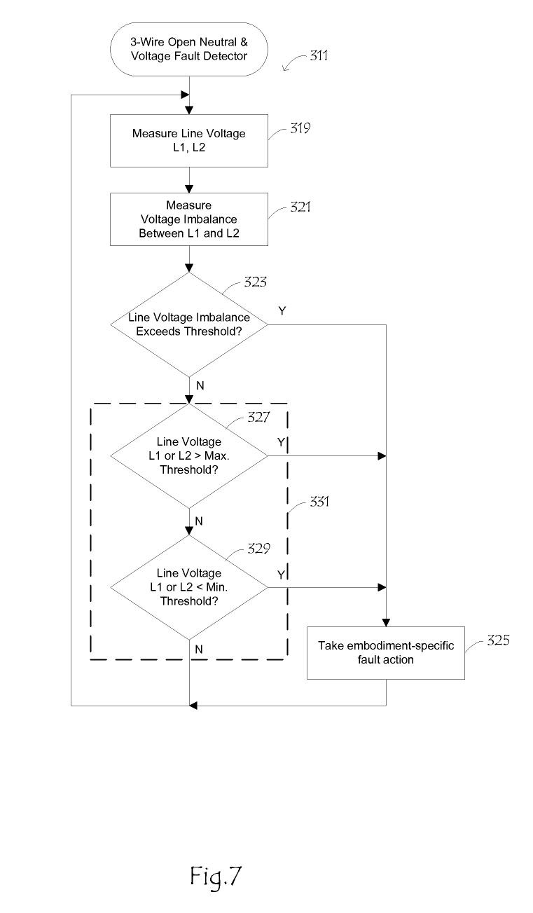

Preferably, and as illustrated in FIG. 7, a method 311 which is another embodiment of the invention includes, initially, a step 319 of measuring the first voltage between the first live conductor and the neutral conductor, and the second voltage between the second live conductor and the neutral conductor. Next, the voltage imbalance between the measured first voltage and the measured second voltage is determined (step 321). Next, the imbalance is compared to the predetermined threshold value, to determine whether the imbalance is greater than the predetermined threshold value (step 323). If the imbalance exceeds the predetermined threshold value, then the alarm signal is generated (step 325). If the voltage imbalance does not exceed the predetermined threshold value, then the process proceeds to the next step. In the next step, the first voltage and the second voltage are compared to a predetermined maximum voltage (step 327). If either of the first voltage or the second voltage exceeds the predetermined maximum voltage, then an alarm signal is generated (step 325). If neither of the first voltage nor the second voltage exceeds the predetermined maximum voltage, then the first voltage and the second voltage are compared to a predetermined minimum voltage (step 329). If either of the first voltage or the second voltage is less than the predetermined minimum voltage, then the alarm signal is generated (step 325).

It will be understood that the method 311 may be applied to determine whether the first voltage and the second voltage (or either of them, as the case may be) is outside a range defined by the predetermined maximum voltage and the predetermined minimum voltage (step 331). If any one of the first voltage and the second voltage is outside the range, the alarm signal is generated (step 325).

It will be understood that the open neutral fault detector 10 may be adapted to carry out the method 311 of the invention.

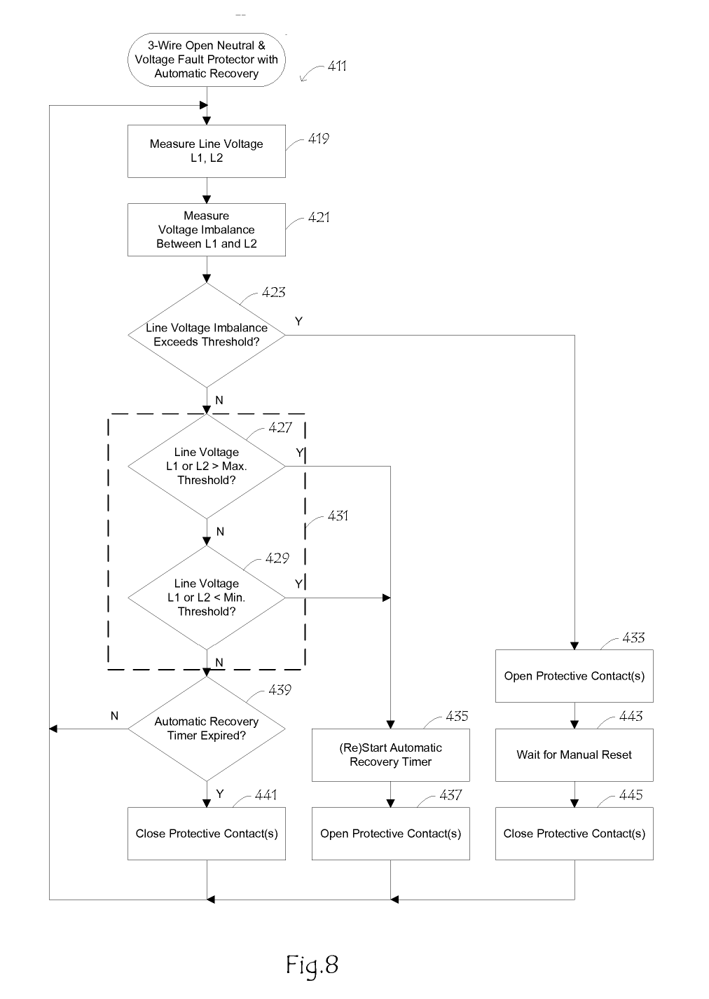

A method 411 which is another embodiment of the invention is illustrated in FIG. 8. The method 411 includes, initially, a step 419 of measuring the first voltage between the first live conductor and the neutral conductor, and the second voltage between the second live conductor and the neutral conductor. Next, the voltage imbalance between the measured first voltage and the measured second voltage is determined (step 421). In the next step, the voltage imbalance is compared to the predetermined threshold value, to determine whether the imbalance exceeds the predetermined threshold value (step 423). If the line voltage imbalance exceeds the predetermined threshold value, then an alarm signal is generated and the means for disconnection disconnects the live conductors L1, L2 (step 433). If the line voltage imbalance does not exceed the predetermined threshold value, then the first voltage and the second voltage are compared to a predetermined maximum voltage (step 427).

The alarm signal is generated when one of the first and second voltages exceeds the predetermined maximum voltage, and the live conductors are disconnected as a result (step 437). Upon generation of the alarm signal, the automatic recovery timer is also started (step 435), which is intended to provide a means for reconnecting the live conductors after a fault involving excessive or insufficient line voltage (i.e., exceeding the predetermined maximum, or lower than the predetermined minimum) has been remedied. In one embodiment, the line voltages are repeatedly measured at predetermined time intervals, and the automatic recovery timer restarts at the preselected intervals at which line voltages are measured while there is a fault. In this situation, if the fault continues, then the timer is restarted at each time interval while there is a fault condition. If the fault does not continue (i.e., the fault is remedied), then the timer is not restarted, and the timer is allowed to proceed until the end of its time period (step 439), at which time the live conductors are reconnected (step 441).

The situation is different if the live conductors have been disconnected due to the line voltage imbalance exceeding the predetermined threshold value. In this situation, after the live conductors have been disconnected (step 433), they remain open, awaiting manual reset (step 443). Accordingly, specific intervention of the user is required in order to remedy the open neutral fault condition which caused the excessive line voltage imbalance. Once the open neutral fault condition has been remedied, the live conductors are reconnected (step 445).

It will be understood that the open neutral fault detector 10 may be adapted to carry out the method 411 of the invention.

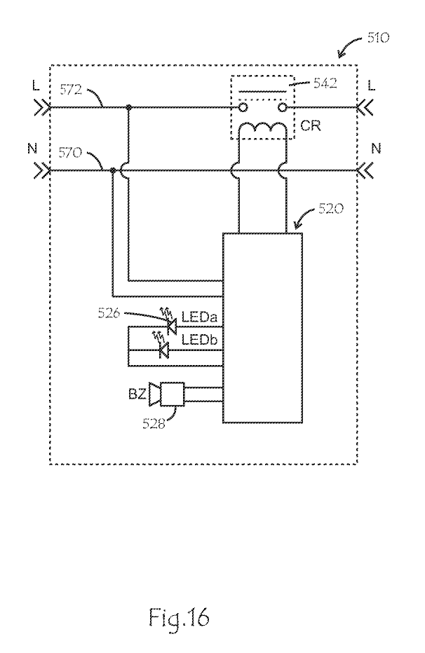

Another embodiment of an open neutral fault detector 510 of the invention is illustrated in FIG. 16. The open neutral fault detector 510 is for monitoring an electrical circuit including a neutral conductor and two live conductors. The open neutral fault detector 510 is installed in a branch circuit 568 including the neutral conductor 570 and a selected one 572 of the live conductors.

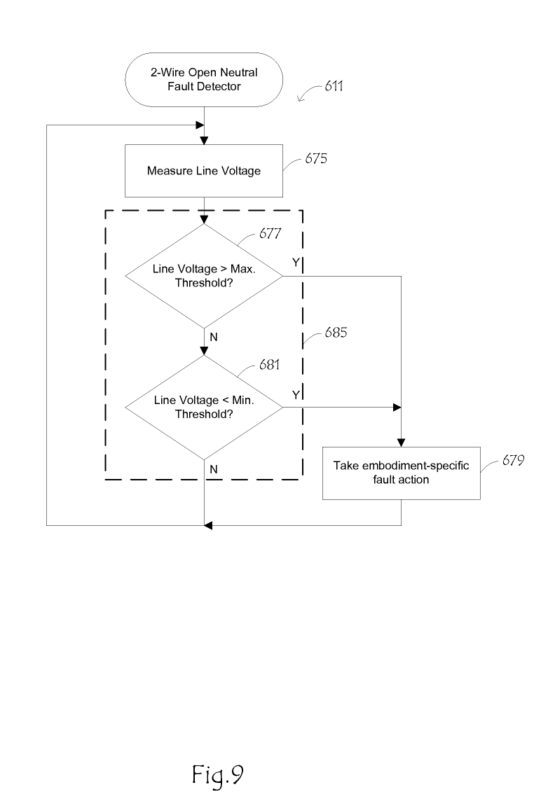

An embodiment of a method 611 of the invention for detecting an open neutral fault in which the open neutral fault detector 510 is used is illustrated in FIG. 9. As can be seen in FIG. 9, the method begins at step 675 in which a line voltage between the live conductor 572 and the neutral conductor 570 is measured.

In the method 611, the voltage is compared to a predetermined maximum voltage (step 677). If the voltage exceeds the predetermined maximum voltage, then an alarm signal is generated (step 679). If the line voltage does not exceed the predetermined maximum voltage, then, in step 681, the line voltage is compared to a predetermined minimum voltage. If the line voltage is less than the predetermined minimum voltage, then the alarm signal is generated (step 679).

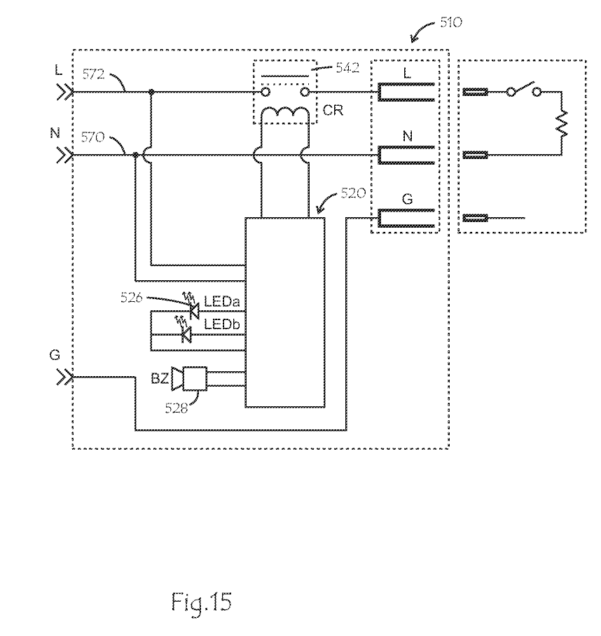

As shown in FIG. 16, the open neutral fault detector 510 preferably includes a control circuit 520. Preferably, and as shown in FIGS. 15-17, the open neutral fault detector also includes one or more of: a means 526 for providing a predetermined visual signal; a means 528 for providing a predetermined audible signal; and/or a means 542 for disconnecting the live conductor 572.

It will be understood that the method 611 may be applied to determine whether the line voltage is outside a range defined by the predetermined maximum voltage and the predetermined minimum voltage (step 685). If the line voltage is outside the range, the alarm signal is generated and the live conductor is disconnected (step 679).

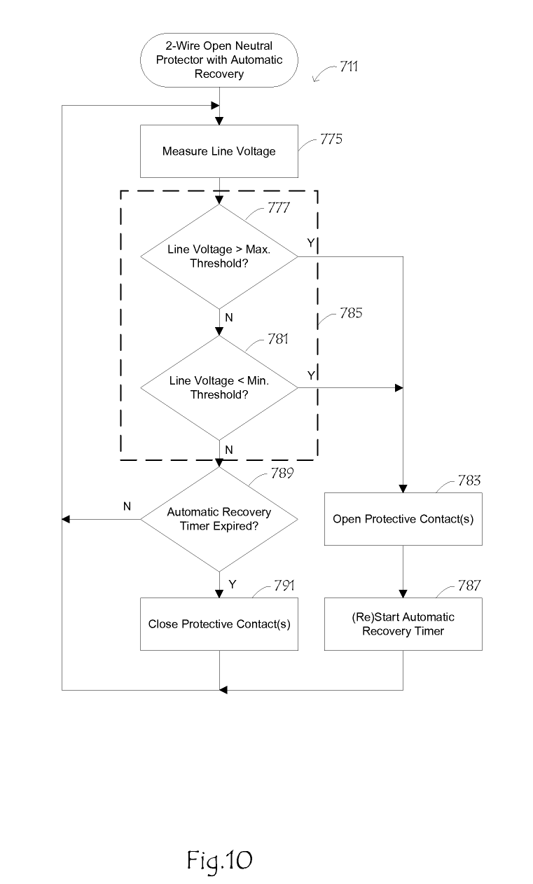

FIG. 10 illustrates another embodiment 711 of the method of the invention in which the open neutral fault detector 510 is used. As can be seen in FIG. 10, after line voltage is measured (step 775), the voltage is compared to predetermined maximum voltage (step 777). If the voltage exceeds the predetermined maximum voltage, then an alarm signal is generated and the live conductor is disconnected (step 783). If the line voltage does not exceed the predetermined maximum voltage, then the line voltage is compared to a predetermined minimum voltage. If the line voltage is less than the predetermined minimum voltage, then the alarm signal is generated, and the live conductor is disconnected (step 783).

It will be understood that the method 711 may be applied to determine whether the line voltage is outside a range defined by the predetermined maximum voltage and the predetermined minimum voltage (step 785). If the line voltage is outside the range, the alarm signal is generated and the live conductor is disconnected (step 783).

The alarm signal is generated when the line voltage exceeds the predetermined maximum voltage, or when the line voltage is less than the predetermined minimum voltage, and the live conductor is disconnected as a result (step 783). Upon generation of the alarm signal, an automatic recovery timer is also started, which is intended to provide a means for reconnecting the live conductor after a fault involving excessive or insufficient line voltage has been remedied. In one embodiment, the live voltage is repeatedly measured at predetermined time intervals, and the automatic recovery timer restarts at the preselected intervals at which the line voltage is measured while there is a fault. If in this situation, if the fault continues, then the timer is restarted (step 787) at each time interval while there is a fault condition. If the fault does not continue (i.e., the fault is remedied), then the timer is not restarted and the timer is allowed to proceed until the end of its time period (step 789), at which time the live conductor is reconnected (step 791).

It will be understood that the open neutral fault detector 510 may be adapted to carry out the method 711 of the invention.

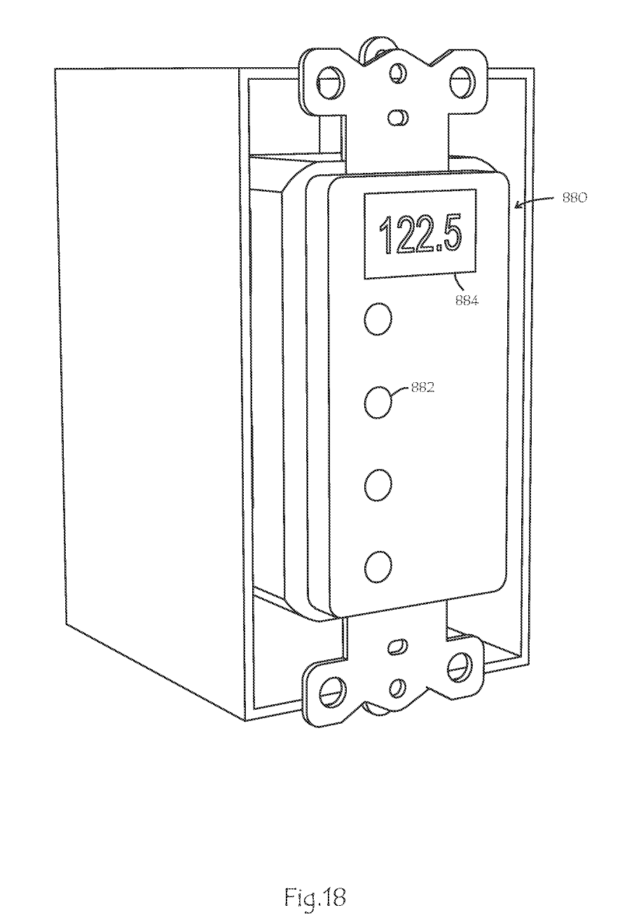

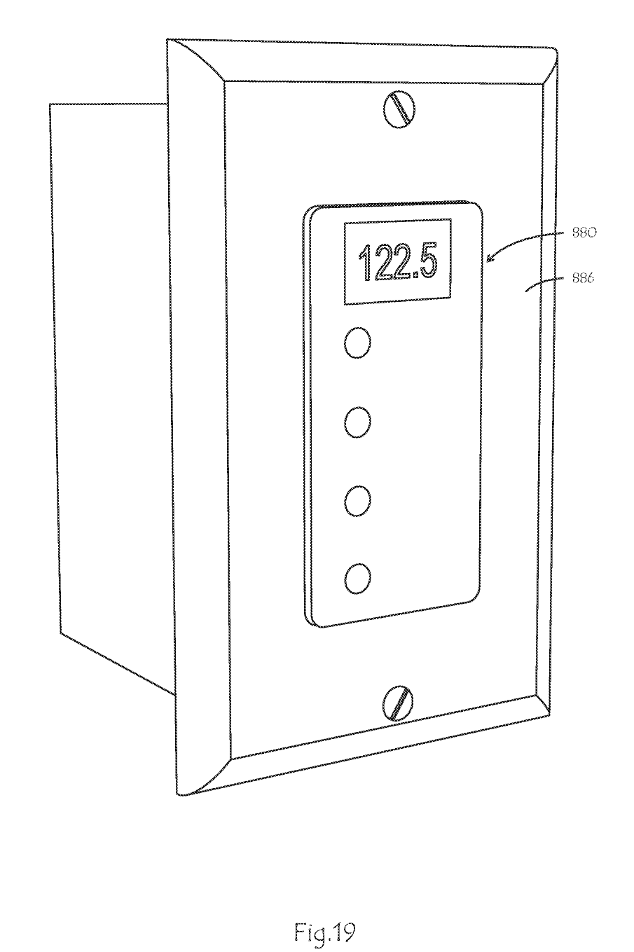

FIG. 18 is an isometric view of an indicator assembly 880. As shown, the indicator assembly 880 includes a plurality of light sources 882 adapted to provide the predetermined visual signal indicating a fault. The indicator subassembly also may include a display 884 indicating voltage. Preferably, and as shown in FIG. 19, the assembly includes a cover plate 886. The advantage of the assembly 880 is that the open neutral fault detector can be mounted therein, i.e., in a standard box.

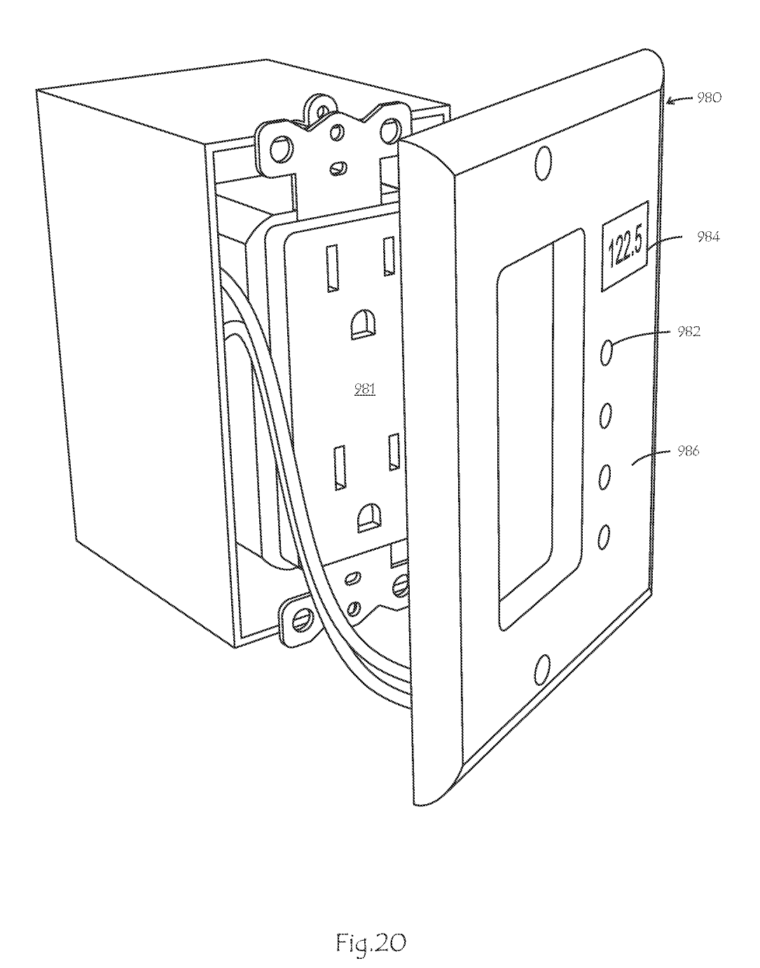

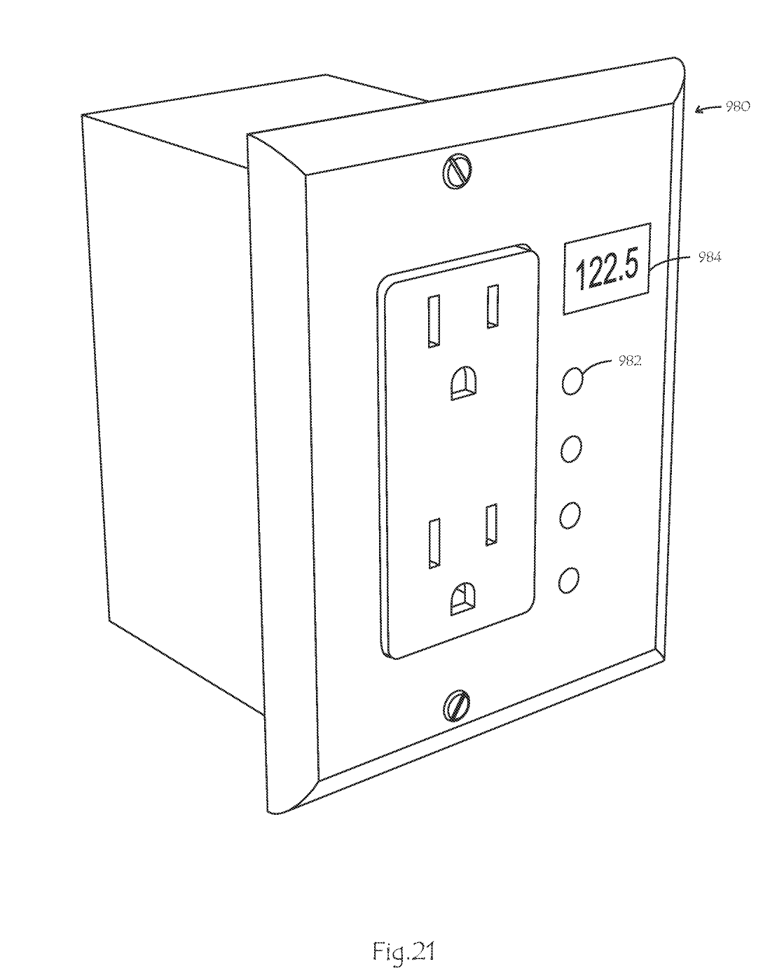

FIG. 20 discloses an indicator subassembly 980 adapted to be positioned on an existing receptacle 981. As can be seen in FIGS. 20 and 21, the light sources 982 and a display 984 are positioned on a cover plate 986. The open neutral fault detector can be included in the cover plate assembly and retrofitted over an existing standard receptacle.

Any element in a claim that does not explicitly state “means for” performing a specific function, or “step for” performing a specific function, is not to be interpreted as a “means” or “step” clause as specified in 35 U.S.C. §112, par. 6.

It will be appreciated by those skilled in the art that the invention can take many forms, and that such forms are within the scope of the invention as claimed. Therefore, the spirit and scope of the appended claims should not be limited to the descriptions of the preferred versions contained herein.

We claim:

1. An open neutral fault detector for monitoring an electrical circuit comprising a neutral conductor and first and second live conductors, the open neutral fault detector comprising:
means for determining a voltage imbalance between:
a first voltage between the first live conductor and the neutral conductor; and
a second voltage between the second live conductor and the neutral conductor;
means for comparing the voltage imbalance to a predetermined threshold value; and
means for generating an alarm signal if the voltage imbalance exceeds the predetermined threshold value.

2. An open neutral fault detector according to claim 1 in which the predetermined threshold value is variable.

3. An open neutral fault detector according to claim 1 in which the voltage imbalance is repeatedly determined at preselected time intervals.

4. An open neutral fault detector according to claim 1 additionally comprising means for receiving the alarm signal and means for disconnecting the first and second live conductors upon receipt of the alarm signal.

5. An open neutral fault detector according to claim 1 additionally comprising means for receiving the alarm signal and means for providing a predetermined visual signal upon receipt of the alarm signal.

6. An open neutral fault detector according to claim 1 additionally comprising means for receiving the alarm signal and means for providing a predetermined audible signal upon receipt of the alarm signal.

7. An open neutral fault detector for monitoring an electrical circuit comprising a neutral conductor and first and second live conductors, the open neutral fault detector comprising:
means for measuring a first voltage between the first live conductor and the neutral conductor;
means for measuring a second voltage between the second live conductor and the neutral conductor;
means for comparing the first voltage and the second voltage and determining an imbalance therebetween; and
means for generating an alarm signal if the imbalance is greater than a predetermined threshold value.

8. An open neutral fault detector according to claim 7 in which the predetermined threshold value is variable.

9. An open neutral fault detector according to claim 7 additionally comprising:
means for comparing the first voltage to a voltage limit selected from the group consisting of a predetermined maximum voltage and a predetermined minimum voltage;
means for comparing the second voltage to the voltage limit; and
means for generating the alarm signal upon any one of the first voltage and the second voltage violating the voltage limit.

10. An open neutral fault detector according to claim 9 in which the predetermined maximum voltage and the predetermined minimum voltage are variable.

11. An open neutral fault detector according to claim 7 additionally comprising:
means for comparing the first voltage to a range defined by a predetermined maximum voltage and a predetermined minimum voltage;
means for comparing the second voltage to the range; and
means for generating the alarm signal upon any one of the first voltage and the second voltage being outside the range.

12. An open neutral fault detector according to claim 11 in which the predetermined maximum voltage and the predetermined minimum voltage are variable.

13. An open neutral fault detector according to claim 7 in which the first and second voltages are substantially simultaneously measured repeatedly at preselected time intervals and the first and second voltages for each said preselected time interval are compared respectively.

14. An open neutral fault detector according to claim 7 additionally comprising means for receiving the alarm signal and means for disconnecting the first and second live conductors upon receipt of the alarm signal.

15. An open neutral fault detector according to claim 14 additionally comprising means for reconnecting the first and second live conductors upon expiry of a preselected recovery time period.

16. An open neutral fault detector according to claim 7 additionally comprising means for receiving the alarm signal and means for providing a predetermined visual signal upon receipt of the alarm signal.

17. An open neutral fault detector according to claim 7 additionally comprising means for receiving the alarm signal and means for providing a predetermined audible signal upon receipt of the alarm signal.

18. An open neutral fault detector for monitoring an electrical circuit comprising a neutral conductor and first and second live conductors, the open neutral fault detector being installed in a branch circuit comprising the neutral conductor and a selected one of the live conductors, the open neutral fault detector comprising:
means for measuring a voltage between the selected live conductor and the neutral conductor;
means for comparing the voltage to a voltage limit selected from the group consisting of a predetermined upper limit and a predetermined lower limit; and
means for generating an alarm signal if the voltage violates the voltage limit.

19. An open neutral fault detector according to claim 18 additional comprising means for comparing the voltage to a range defined by the predetermined upper limit and the predetermined lower limit and means for generating the alarm signal if the voltage is outside the range.

20. An open neutral fault detector according to claim 19 in which the predetermined upper limit and the predetermined lower limit are variable.

21. An open neutral fault detector according to claim 18 in which the predetermined upper limit and the predetermined lower limit are variable.

22. An open neutral fault detector according to claim 18 in which the voltage between the live conductor and the neutral conductor is repeatedly measured at preselected time intervals.

23. An open neutral fault detector according to claim 18 additionally comprising means for receiving the alarm signal and means for disconnecting the live conductor from the circuit upon receipt of the alarm signal.

24. An open neutral fault detector according to claim 23 additionally comprising means for reconnecting the live conductor upon expiry of the preselected recovery time period.

25. An open neutral fault detector according to claim 18 additionally comprising means for receiving the alarm signal and means for providing a predetermined visual signal upon receipt of the alarm signal.

26. An open neutral fault detector according to claim 25 in which the visual signal is provided via at least one visual signal generator at least partially positioned in a cover plate subassembly.

27. An open neutral fault detector according to claim 18 additionally comprising means for receiving the alarm signal and means for providing a predetermined audible signal upon receipt of the alarm signal.

28. A method for detecting an open neutral fault condition in a circuit comprising a neutral conductor and first and second live conductors, the method comprising:
(a) determining a voltage imbalance between:
a first voltage between the first live conductor and the neutral conductor; and
a second voltage between the second live conductor and the neutral conductor;
(b) comparing the voltage imbalance to a predetermined threshold value; and
(c) generating an alarm signal if the voltage imbalance exceeds the predetermined threshold value.

29. A method for detecting an open neutral fault condition in an electrical circuit comprising a neutral conductor and first and second live conductors, the method comprising:
(a) measuring a first voltage between the first live conductor and the neutral conductor;
(b) measuring a second voltage between the second live conductor and the neutral conductor;
(c) comparing the first voltage and the second voltage to determine an imbalance therebetween; and
(d) generating an alarm signal if the imbalance is greater than a predetermined threshold value.

30. A method according to claim 29 additionally comprising:
(e) comparing the first voltage to a voltage limit selected from the group consisting of a predetermined maximum voltage and a predetermined minimum voltage;
(f) comparing the second voltage to the voltage limit;
(g) generating the alarm signal upon any one of the first voltage and the second voltage violating the voltage limit.

31. A method according to claim 29 additionally comprising:
(e) comparing the first voltage to a range defined by a predetermined maximum voltage and a predetermined minimum voltage;
(f) comparing the second voltage to the range;
(g) generating the alarm signal upon any one of the first voltage and the second voltage being outside the range.

32. A method for detecting an open fault condition in a branch circuit comprising a neutral conductor and a live conductor, the method comprising:
(a) measuring a voltage between the live conductor and the neutral conductor;
(b) comparing the voltage to a voltage limit selected from the group consisting of a predetermined maximum voltage and a predetermined minimum voltage; and
(c) generating an alarm signal if the voltage violates the voltage limit.

33. A method for detecting an open fault condition in a branch circuit comprising a neutral conductor and a live conductor, the method comprising:
(a) measuring a voltage between the live conductor and the neutral conductor;
(b) comparing the voltage to a range defined by a predetermined maximum voltage and a predetermined minimum voltage; and
(c) generating an alarm signal if the voltage is outside the range.
